(19) United States
(12) Patent Application Publication
(10) Pub. No.: US 2004/0020945 A1
(43) Pub. Date: Feb. 5, 2004

(54) Mixing apparatus

(75) Inventors: Paul M. Aumuller, Richmond Hill (CA); Paolo Accettone, Pickering (CA)

Correspondence Address: HOFBAUER ASSOCIATES, SUITE 205 NORTH, 1455 LAKESHORE ROAD, BURLINGTON, ON, L7S 2J1, CA

(73) Assignee: IX Research Ltd., Richmond Hill (CA)

(21) Appl. No.: 10/630,667

(22) Filed: Jul. 31, 2003

(30) Foreign Application Priority Data
Jul. 31, 2002 (CA) 2,396,073

(51) Int. Cl. B67D 1/00

(52) U.S. Cl. 222/196; 222/630

(57) ABSTRACT

Disclosed is a mixer comprising a receptacle, a support, a gas tube and a shaker. The receptacle defines a chamber including a lower portion for receiving a supply of particulate material and an upper portion contiguous with the lower portion. The receptacle has an inlet formed therethrough contiguous with the lower portion and an outlet formed therethrough contiguous with the upper portion. A support is provided, for supporting the receptacle for vibratory movement. A gas tube delivers a flow of gas to the inlet. A shaker is connected to the receptacle to effect said vibratory movement in a manner sufficiently vigorous to create a dispersion of said particulate material through which gas delivered to the inlet can diffuse to the outlet, at least a portion of said dispersion being fluidized so as to issue, with said gas, through the outlet as a flow of gas having particulate material entrained therewithin.

### FIELD OF THE INVENTION

The present invention relates to the field of air abrasion, and more particularly, relates to a mixing apparatus of the type used in an air abrasion device to produce a flow of gas having particulate abrasive material entrained therewithin for subsequent delivery to a nozzle so as to issue therefrom as a blast of gas having particulate abrasive material entrained therewithin.

### BACKGROUND OF THE INVENTION

Air abrasion techniques, wherein a blast of gas having particulate abrasive material entrained therewithin is directed against an object to be abraded, have long been applied in industry. For example, it is widely known to utilize air abrasion techniques to clean masonry surfaces. In industrial applications of this type, the associated equipment utilized to produce the blast is necessarily large and expensive.

The use of air abrasion techniques on a relatively smaller scale, for example, in dentistry, is becoming more commonplace, and accordingly, relatively smaller air abrasion equipment is becoming available.

In one known class of dental air abrasion equipment, a mixing apparatus is provided which includes a funnel assembly, to receive particulate abrasive material, as well as means for vibrating the funnel assembly, to fluidize the abrasive material and permit the same to flow, by gravity, through an outlet of the funnel assembly, such that gas directed past the outlet can entrain the fluidized particulate abrasive material and carry same to the nozzle. The device described in U.S. Pat. No. 5,618,177 (Abbott), issued Apr. 8, 1997, is exemplary in this regard.

This known class of equipment is known to be capable of providing an effective blast. However, in order to best provide for fluidization, it has been found necessary to make the central portion of the funnel assembly more rigid than the top and bottom portions thereof. This effect can be provided by a simple funnel, having weakened top and bottom portions, but this solution makes it difficult to mount the funnel, and impacts deleteriously on the overall reliability of the structure. As an alternative which avoids these drawbacks, the funnel assembly may comprise a funnel and a separate diaphragm, the diaphragm being connected to the bottom of the funnel in a manner such that they do not together form a rigid, resonant body; however, this alternative adds to the cost and complexity of the device.

### SUMMARY OF THE INVENTION

It is an object of the present invention to provide a mixing apparatus which is relatively simple and economical to construct and operate and relatively reliable in operation.

This object, among others, is achieved by the present invention, a mixing apparatus for use with a supply of particulate material and a flow of gas.

As one aspect of the invention, the mixing apparatus comprises a hollow receptacle, support means, gas input means and vibratory means.

The receptacle defines a chamber including a lower portion for receiving said supply of particulate material and an upper portion contiguous with and overlying said lower portion.

The receptacle has an inlet port formed therethrough contiguous with the lower portion of the chamber and an outlet port formed therethrough contiguous with the upper portion of the chamber.

The support means is for supporting the receptacle for vibratory movement.

The gas input means is for receiving the flow of gas and delivering same to the inlet port.

The vibratory means is for effecting said vibratory movement of the receptacle in a manner sufficiently vigorous to create a dispersion of said particulate material through which gas delivered to the inlet port can diffuse to the outlet port, at least a portion of said dispersion being fluidized so as to issue, with said gas, through the outlet port as a flow of gas having particulate material entrained therewithin.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinbelow.

### BRIEF DESCRIPTION OF THE DRAWINGS

FIG. 1 is a top, front, left side perspective view of a mixing apparatus according to a preferred embodiment of the present invention.

FIG. 2 is a top plan view of the mixing apparatus of FIG. 1.

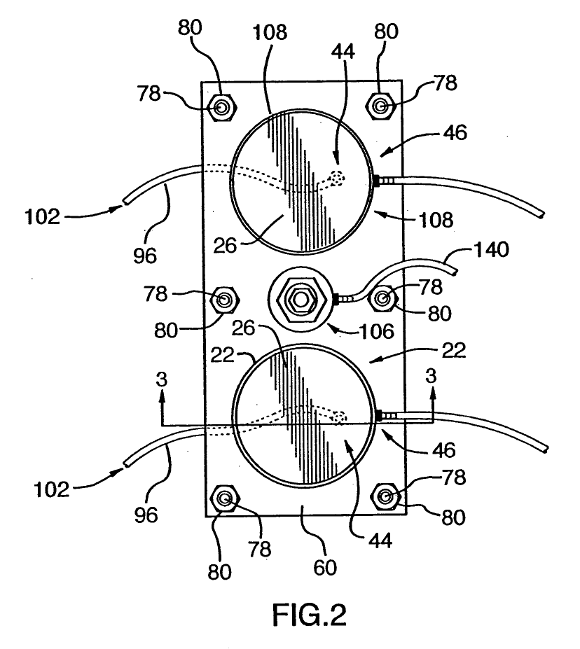

FIG. 3 is a cross-sectional view of the structure of FIG. 1, along sight line 3-3 of FIG. 2.

FIG. 4 is a schematic representation of the apparatus of FIG. 1, in use.

### DETAILED DESCRIPTION OF A PREFERRED EMBODIMENT

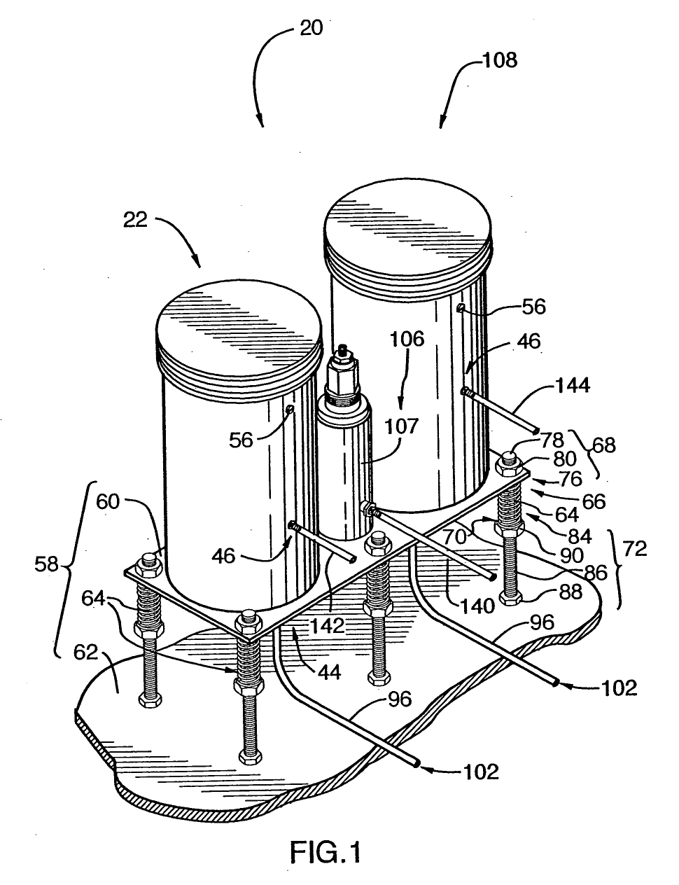

Referring now to FIG. 1 of the drawings, a mixing apparatus according to a preferred embodiment of the present invention is illustrated and designated with general reference numeral 20.

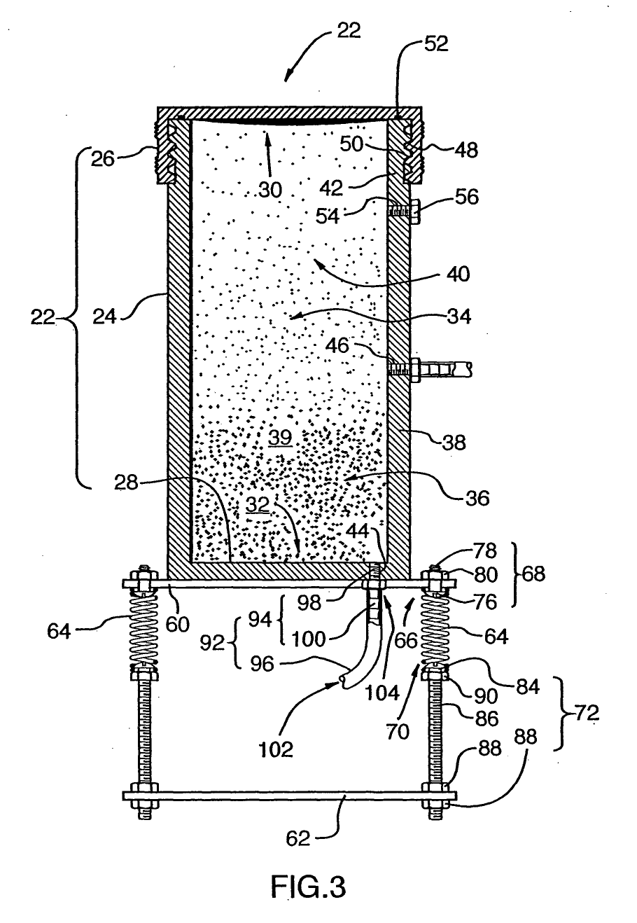

As will be evident, the preferred mixing device comprises a hollow receptacle, designated with general reference numeral 22 in FIG. 1. The receptacle 22 is best viewed in FIG. 3, wherein it will be seen to comprise a tubular cylindrical side wall 24, a tube cap 26 and a tube bottom wall 28, the side wall 24 extending between and defining vertically spaced-apart tube ends 30,32 occluded, respectively, by the tube cap 26 and the tube bottom wall 28, so as to define a chamber 34. The chamber 34 includes a lower portion 36, defined by a lower section 38 of the side wall 24 and the tube bottom wall 28, for receiving a supply of particulate material 39. The chamber 34 further includes an upper portion 40, contiguous with and overlying the lower portion 36, defined by an upper section 42 of the side wall 24 and the tube cap 26. A threaded inlet port 44 is formed through the tube bottom wall 28 adjacent to the side wall 24, so as to be contiguous with the lower portion 36 of the chamber 34, and a threaded outlet port 46 is formed through the upper section 42 of the side wall 24, so as to be contiguous with the upper portion 40 of the chamber 34. In order to provide access to the chamber 34, the tube cap 26 is not permanently affixed to the side wall 24, but rather is threaded thereto by suitable threads 48,50 provided on the interior of the tube cap 26 and the exterior of the side wall 24, respectively. To prevent loss of internal pressure, the tube cap 26 is sealed against the side wall 24 by a rubber gasket 52. To selectively release internal pressure, for example, when the tube cap 26 is to be removed, a threaded bore 54 is provided through the side wall 24, within which is sealingly, removably seated a venting bolt 56. The side wall 24, the tube cap 26, the tube bottom wall 28 and the venting bolt 56 are constructed of anodized aluminum.

The apparatus further comprises support means, designated with general reference numeral 58 in FIG. 1, for supporting the receptacle 22 for vibratory movement. The preferred support means 58 comprises a platform 60 upon which the receptacle 22 is mounted, by bolts (not shown), a base 62 positioned beneath the platform 60, and one or more legs 64, each comprised of a spring and operatively extending between and connecting the base 62 to the platform 60 so as to operatively connect the base 62 to the receptacle 22. As best illustrated in FIG. 3, the upper end 66 of each spring 64 is mounted to the platform 60 by a first nut and bolt assembly 68, and the lower end 70 of each spring 64 is mounted to the base 62 by a second nut and bolt assembly 72. More particularly, each first nut and bolt assembly 68 includes a bolt having a head 76 disposed beneath the platform 60 and a shaft 78 which extends from the head 76, through the platform 60, to be received by a nut 80, with the upper end 66 of a respective spring 64 being captured between the head 76 and the platform 60. Each second nut and bolt assembly 72 includes a bolt having a head 84 and shaft 86. The shaft 86 depends from the head 84 through the base 62, and is secured to the base 62 by a pair of nuts 88,88 disposed on opposite faces of the base 62, with the lower end 70 of a respective spring 64 being captured between the head 84 and a further nut 90 threaded on the shaft 86.

Gas input means for receiving the flow of gas and delivering same to the inlet port 44 is also provided and designated with general reference numeral 92 in FIG. 3. As illustrated, the gas input means 92 comprises a inlet nipple 94 and a gas input tube 96. The inlet nipple 94 includes a threaded portion 98 and a stepped portion 100, with the threaded portion 98 being engaged within the inlet port 44. The gas input tube 96 has a first end 102 adapted to receive said flow of gas and a second end 104 frictionally engaged about the stepped portion 100 of the inlet nipple 94.

The apparatus additionally includes vibratory means, designated with general reference numeral 106 in FIG. 1, for effecting said vibratory movement of the receptacle 22 in a manner sufficiently vigorous to create a dispersion of said particulate material through which gas delivered to the inlet port 44 can diffuse to the outlet port 46, at least a portion of said dispersion being fluidized so as to issue, with said gas, through the outlet port 46 as a flow of gas having particulate material entrained therewithin.

As illustrated, the vibratory means 106 comprises a shaker rigidly mounted on the platform 60 and thereby operatively rigidly mounted to the receptacle 22. In the preferred embodiment, the shaker is comprised of a small, pneumatic rotary motor 107 with an eccentric weight or cam mounted on its shaft (not shown) and couplable to the flow of gas by a drive gas tube 140 for actuation.

It will be evident that the aforedescribed structure may on its own be usefully deployed in combination with a nozzle and a gas delivery means for receiving from the outlet port the flow of gas having particulate abrasive material entrained therewithin and delivering same to the nozzle to provide an abrasion device (not shown) which is is relatively simple and economical to construct and operate and relatively reliable in operation.

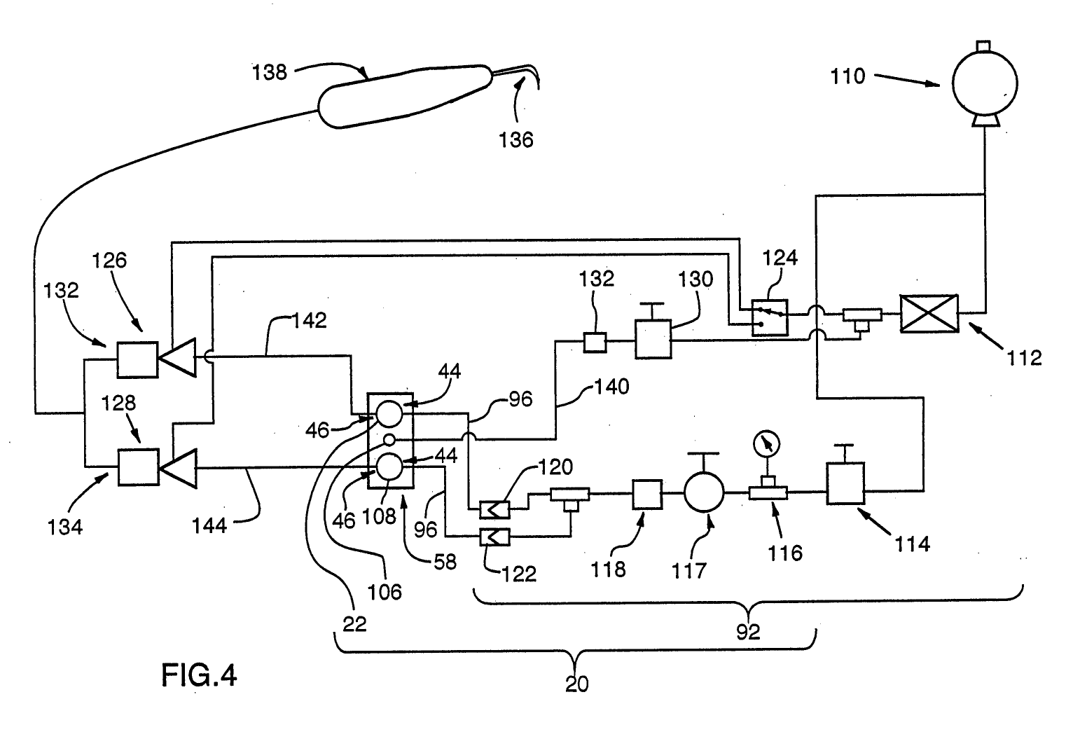

However, in addition to the foregoing, the preferred mixing apparatus includes an auxiliary receptacle 108, substantially identical to receptacle 22, for reasons which will become clear upon consideration of the following paragraphs, which describe an abrasion device which incorporates the preferred mixing apparatus and which is represented schematically in FIG. 4.

As indicated, the abrasion device includes the preferred mixing apparatus 20, and thus, includes the receptacle 22, the auxiliary receptacle 108, the support means 58, the gas input means 92 and the vibratory means 106.

Also included is an air compressor 110, which is connected to a foot actuable air valve 112 and a first air pressure regulator 114. Air delivered by the compressor 110 to the first air pressure regulator 114 passes therefrom, at a pressure selected by means of said first air pressure regulator 114, measured by an air pressure gauge 116, through an air flow regulator 117 and a first filter 118, to a first check valve 120 and to a second check valve 122, which, in turn, lead to the inlet ports 44,44 of the receptacle 22 and the auxiliary receptacle 108, respectively. Air delivered by the compressor 110 to the foot actuable valve 112 selectively passes therefrom to a two position switch 124, for selective passage to the respective trigger of either of a first pneumatic pinch valve 126 or a second pneumatic pinch valve 128. Air also passes from the foot actuable switch 112 through a second air pressure regulator 130 and a second filter 132 to the inlet of the pneumatic shaker 106. The outlet port 46 of the receptacle 22 is coupled to the inlet of the first pneumatic pinch valve 126 via first outlet tube 142. The outlet port 46 of the auxiliary receptacle 108 is coupled via second outlet tube 144 to the inlet of the second pneumatic pinch valve 128. The outlets 132,134 of the first pneumatic pinch valve 126 and the second pneumatic pinch valve 128 merge, and are coupled to a nozzle 136 of a hand-. held blasting tool 138.

In operation, activation of the foot actuable air valve 112 allows air to be passed from the compressor 110 through to the pneumatic shaker 106, to disperse any contents of the receptacle 22 and the auxiliary receptacle 108. Regulator 130 may be adjusted to provide a desired level of vibration.

Air further passes through to trigger such of the pneumatic pinch valves 126,128 as is selected on the two position switch 124, thereby to permit a flow of gas having particulate material entrained therewithin to flow from the receptacle 22, 108 connected to said selected pinch valve 126,128 to the nozzle 136. Identical particulate abrasive materials may advantageously be provided in each of the receptacle 22 and auxiliary receptacle 108, so as to prolong the length of time between fillings, when used in a dental operatory. Alternatively, different abrasive materials may be provided in each of the receptacle 22 and the auxiliary receptacle 108, for example, 27 micron and 50 micron aluminum oxide, so as to give the user of the abrasion device some flexibility, to suit the particular use to which the abrasion device will be put.

Various modifications and alterations may be used in the design and manufacture of the mixing apparatus of the present invention without departing from the spirit and scope of the invention.

For example, whereas the shaker of the preferred embodiment is a pneumatic shaker, other devices such as electric motors, solenoids and piezoelectric actuators may be utilized with similar utility.

As well, whereas the side wall, the tube cap, the tube bottom wall and the venting screw of the preferred embodiment are constructed from anodized aluminum, it will be evident that any material that can be manufactured into the desired structure, that is relatively easy to clean, that is relatively abrasion-resistant and that can withstand without leakage and significant deformation the pressures may be utilized, such as abrasion-resistant and rigid plastic.

As well, whereas the preferred embodiment contemplates use of the invention in association with particulate aluminum oxide, it will be understood that any particles may be used as long as they are fine enough to be fluidized and delivered in a propellant gas, although aluminum oxide is the generally preferred material for the abrasive treatment of teeth. Further, it will be understood that the invention is not limited to use in the field of dentistry and could, for example, be used in glass etching, or even for general dispensing of powders.

Additionally, whereas the tube cap of the preferred embodiment is threaded to the side wall, it will be evident that other attachment means could be utilized.

Accordingly, it will be understood that the scope of the invention is limited only by the accompanying claims, purposively construed.

We claim:

1. A mixing apparatus for use with a supply of particulate material and a flow of gas, said apparatus comprising:
a hollow receptacle defining a chamber including a lower portion for receiving said supply of particulate abrasive material and an upper portion contiguous with and overlying said lower portion, the receptacle having an inlet port formed therethrough contiguous with the lower portion of the chamber and an outlet port formed therethrough contiguous with the upper portion of the chamber;
support means for supporting the receptacle for vibratory movement;
gas input means for receiving the flow of gas and delivering same to the inlet port; and
vibratory means for effecting said vibratory movement of the receptacle in a manner sufficiently vigorous to create a dispersion of said particulate material through which gas delivered to the inlet port can diffuse to the outlet port, at least a portion of said dispersion being fluidized so as to issue, with said gas, through the outlet port as a flow of gas having particulate material entrained therewithin.

2. A mixing apparatus according to claim 1, wherein the receptacle includes a tubular side wall, a tube cap and a tube bottom wall, the side wall extending between and defining vertically spaced-apart tube ends occluded, respectively, by the tube cap and the tube bottom wall.

3. A mixing apparatus according to claim 2, wherein the side wall includes an upper section which, in combination with the tube cap defines the upper portion of the chamber, and a lower section which, in combination with the tube bottom wall defines the lower portion of the chamber.

4. A mixing apparatus according to claim 3, wherein the inlet receptacle is formed through the tube bottom wall.

5. A mixing apparatus according to claim 4, wherein the inlet receptacle is formed through the tube bottom wall adjacent to the side wall.

6. A mixing apparatus according to claim 5, wherein the outlet port is formed through the upper section of the side wall.

7. A mixing apparatus according to claim 5, wherein the side wall is cylindrical.

8. A mixing apparatus according to claim 6, wherein the support means comprises a base and one or more legs, each of said one or more legs extending between and operatively connecting the base to the receptacle.

9. A mixing apparatus according to claim 8, wherein each of said one or more legs is comprised of a spring.

10. A mixing apparatus according to claim 9, wherein said one or more legs numbers two or more.

11. A mixing apparatus according to claim 10, wherein the vibratory means comprises a shaker operatively rigidly mounted to the receptacle.

12. A mixing apparatus according to claim 11, wherein the shaker is a pneumatic shaker.

13. A mixing apparatus according to claim 11, wherein the receptacle is mounted on a platform, and each of said one or more legs extends between and connects the base to the platform.

14. A mixing apparatus according to claim 13,- wherein the shaker is mounted on the platform.

15. A mixing apparatus according to claim 14, wherein said gas input means comprises a tube having a first end adapted to receive said flow of gas and a second end coupled to the gas inlet.
